(19) United States
(12) Patent Application Publication
(10) Pub. No.: US 2015/0256558 A1
(43) Pub. Date: Sep. 10, 2015

(54) SAFETY DEVICE, SERVER AND SERVER INFORMATION SAFETY METHOD

(71) Applicant: Shenzhen Microprofit Electronics Co., Ltd, Shenzhen (CN)

(72) Inventors: Lidong Yin, Shenzhen (CN); Ming Qin, Shenzhen (CN); Guorong Yan, Shenzhen (CN); Zongzhen Liu, Shenzhen (CN); Yiqing Cao, Shenzhen (CN); Yanbo Li, Shenzhen (CN); Jing Li, Shenzhen (CN); Wenjing Zhang, Shenzhen (CN); Fulin Ye, Shenzhen (CN)

(21) Appl. No.: 14/338,015

(22) Filed: Jul. 22, 2014

(30) Foreign Application Priority Data
Mar. 7, 2014 (CN) 201410082238.3

(51) Int. Cl. H04L 29/06; G06F 21/60

(52) U.S. Cl. CPC H04L 63/20; G06F 21/60

(57) ABSTRACT

A safety device, a server and a server safety realizing method. The safety device includes: a communication module used to be butted with an external communication interface provided by the server and realize information interaction with the server through the interface; a firmware module used to be pre-configured with at least one safety control policy; and a processing module used to perform at least one of the safety control strategies so as to realize the information safety protection of the server in real time when the server detects the safety device. A high speed safety device integrating the safety control policy, for example, a security chip card, is utilized to protect the safety of the server, realize the safe plug and play function of the server, and realize to process an external server as an independence network and also completely isolate the external server from an internal gateway.

### CROSS-REFERENCE TO RELATED APPLICATIONS

This non-provisional application claims priority under 35 U.S.C. §119(a) on Patent Application No(s). 201410082238.3 filed in P.R. China. on Mar. 7, 2014, the entire contents of which are hereby incorporated by reference.

### TECHNICAL FIELD

The present invention relates to the field of server safety protection technologies, and in particular, to a safety device, a server and a server information safety realizing method.

### BACKGROUND ART

A server is an important component in an information system of an enterprise and public institution. The safety of the server is the footstone of the entire information system. Authoritative data shows that about 80% data in the entire information system is processed by the server. Moreover, with the continuous development of the functions and performances of the server, the dependency of the information system on the server is increasingly larger. Once such events as unexpected shut down, accidental network interruption, hacker attack, important data, missing of important data occur, a very large influence will be caused to the safety of the entire information system, thus causing very severe losses to the enterprise and public institution.

It is known that a safety protection policy of the server relates to the safety problem of a core server of the information system, and can avoid the core server of the information system from being faced with such safety threats as invalid access, information hijacking, intrusion penetration, virus damage, backdoor attacks, privilege attacks, data tampering, data leakage and the like.

In practical application, the mass application and data in the server are the guarantee and foundation for the information system to operate safely, stably and effectively. However, the inventor of the present invention finds that multiple safety products and technologies aiming at the safety of the server at present, such as a traditional firewall, IDS(Intrusion Detection Systems, intrusion detection systems)/IPS(Intrusion Prevention System) are all used to protect the network safety or the safety of the information system itself. However, technologies aiming at performing safety protection on the core server of the information system are lacked. Therefore, the prior art at least has the following potential safety hazards during specific implementation.

First, a physical private network user cannot effectively prevent the risks to the database brought by third party development personnel, third party operation and maintenance personnel, and even internal personnel.

I. The permission of the privileged user is not controlled, so that the privileged user can acquire and tamper with any data at anytime.

II. The defects of Web codes or administrative vulnerability is utilized to realize unauthorized access on the database through foreground penetration.

III. Complete and detailed data auditing means are lacked.

IV. An ultimate user cannot be recorded on the database by applying the data access of a foreground user.

V. Direct attack behavior launched directly aiming at the database by utilizing the safety vulnerability and protocol vulnerability.

VI. Deploying a large number of safety products in a server network cannot effectively protect the core of the applications.

### SUMMARY OF THE INVENTION

To solve at least one of the foregoing technical problems, the objective of the present invention is to provide a server safety realizing method, a device and a server.

In order to achieve the above objectives, the present invention is embodied by the follow technical solution:

A safety device, comprising:

a communication module, used to be butted with an external communication interface provided by a server and realize information interaction with the server through the interface;

a firmware module, used to be pre-configured with at least one safety control policy; and

a processing module, used to perform at least one of the safety control policies so as to realize the information safety protection of the server in real time when the server detects the safety device.

Preferably, the safety device is in communication connection with the external communication interface of the server in a pluggable manner; or

the safety device is integrated on a motherboard of the server, and is in communication connection with the external communication interface of the server.

Preferably, when a network card chip acquires a network data packet, the communication module is used to acquire the network data packet from the network card chip; and the processing module comprises:

a network protocol parsing engine, used to carry out network protocol parsing on the network data packet;

an access control module, used to analyze whether current user access is safe according to a network protocol parsing result and at least one safety control policy acquired from the safety device; if the current user access is safe, then allow the network data packet to pass; otherwise, block the network data packet and notify an audit module to audit; and

the audit module, used to audit the network data packet.

Preferably, the processing module further comprises:

a policy buffer module, used to save the safety control policy updated by a user and update the updated safety control policy to the firmware module when the user accesses the server.

Preferably, the processing module further comprises:

a safety policy matching engine, used to detect the network data packet which is allowed to pass according to at least one safety control policy acquired from the safety device, so as to judge whether the network data packet is allowed to pass; if yes, then allow the network data packet to pass; otherwise, block the network data packet and notify the audit module to audit;

a database protocol parsing engine, used to parse the network data packet which is allowed to pass according to various database protocol characters;

an SQL syntax analysis engine, used to analyze SQL statements parsed by the database protocol parsing engine according to at least one safety control policy acquired from the safety device, so as to judge whether the access to the database is legal;

a database safety policy matching engine, used to perform safety policy matching on the network data packet which is allowed to pass according to at least one safety control policy acquired from the safety device, so as to judge whether the network data packet is allowed to pass; if yes, then allow the network data packet to pass; otherwise, block the network data packet and notify the audit module to audit; and

an encryption-decryption module, used to encrypt and decrypt the network data packet which is allowed to pass according to at least one safety control policy acquired from the safety device.

More preferably, the safety device connected with the server in a pluggable manner is a card or a mobile medium.

A server, is connected with a safety device, and the safety device comprises:

a communication module, used to be butted with an external communication interface provided by a server and realize information interaction with the server through the interface;

a firmware module, used to be pre-configured with at least one safety control policy; and

a processing module, used to perform at least one of the safety control policies so as to realize the information safety protection of the server in real time when the server detects the safety device is connected thereon.

Preferably, the safety device is in communication connection with an external communication interface of the server in a pluggable manner, or

the safety device is integrated on a motherboard of the server, and is in communication connection with the external communication interface of the server.

A server information safety realizing method, comprising the steps of:

providing, by a server, an external communication interface, and realizing information interaction with a safety device through the external communication interface, wherein the safety device is pre-configured with at least one safety control policy; when the safety device is connected to the server and is recognized by the server, performing at least one of the safety control policies in real time so as to realize the information safety protection of the server.

Preferably, the safety device is in communication connection with the external communication interface of the server in a pluggable manner, or

the safety device is integrated on a motherboard of the server, and is in communication connection with the external communication interface of the server.

Preferably, the step of performing at least one of the safety control policies in real time so as to realize the information safety protection of the server when the safety device is connected to the server and is recognized by the server, comprises:

acquiring a network data packet when a user accesses the server;

performing network protocol parsing on the network data packet;

analyzing whether current user access is safe according to a network protocol parsing result and at least one safety control policy acquired from the safety device; if yes, then allowing the network data packet to pass; otherwise, blocking and auditing the network data packet; and

detecting the network data packet which is allowed to pass according to at least one safety control policy acquired from the safety device, so as to judge whether the network data packet is allowed to pass; if yes, then allowing the network data packet to pass; otherwise, blocking the network data packet and notifying the audit module to audit;

parsing the network data packet which is allowed to pass according to the characters of various database protocols;

performing safety policy matching on the network data packet which is allowed to pass according to at least one safety control policy acquired from the safety device, so as to judge whether the network data packet is allowed to pass; if yes, then allow the network data packet to pass; otherwise, block the network data packet and notify the audit module to audit; and

encrypting and to decrypting the network data packet which is allowed to pass according to at least one safety control policy acquired from the safety device.

According to the present invention, one high speed safety device (for example, a security chip card) integrating the safety control policy is utilized to protect the safety of the server, realize the safe plug and play function of the server, and realize to process an external server as an independence network and also completely isolate the external server from an internal gateway. The safety control policies include, but are not limited to application safety policy, data safety policy, operating system safety policy, database safety policy (for example, encryption and decryption policies of database data, encryption and decryption policies of database structures), network safety policy and safety audit policy and the like.

### BRIEF DESCRIPTION OF THE DRAWINGS

FIG. 1 is a functional structural schematic diagram of a safety device according to embodiments of the present invention;

FIG. 2 is a detailed structural schematic diagram of the safety device according to the embodiments of the present invention; and

FIG. 3 is a flow schematic view of a server information safety realizing method according to the embodiments of the present invention.

The objective implementation, function characteristics and excellent effects of the present invention will be further explained hereinafter with reference to the specific embodiments and drawings.

### DETAILED DESCRIPTIONS OF THE PREFERRED EMBODIMENTS

The technical solution of the present invention is further described in details with reference to the drawings and specific embodiments, so that those skilled in the art may better understand and implement the present invention. However, the embodiments listed are not intended to limit the present invention.

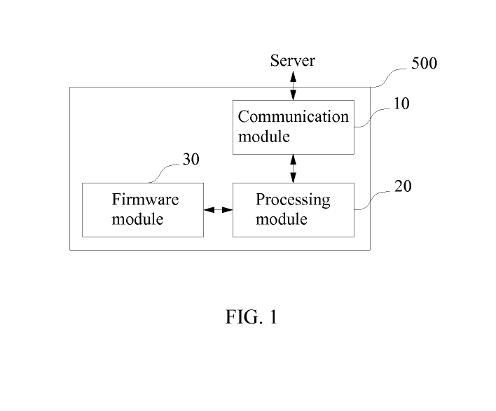

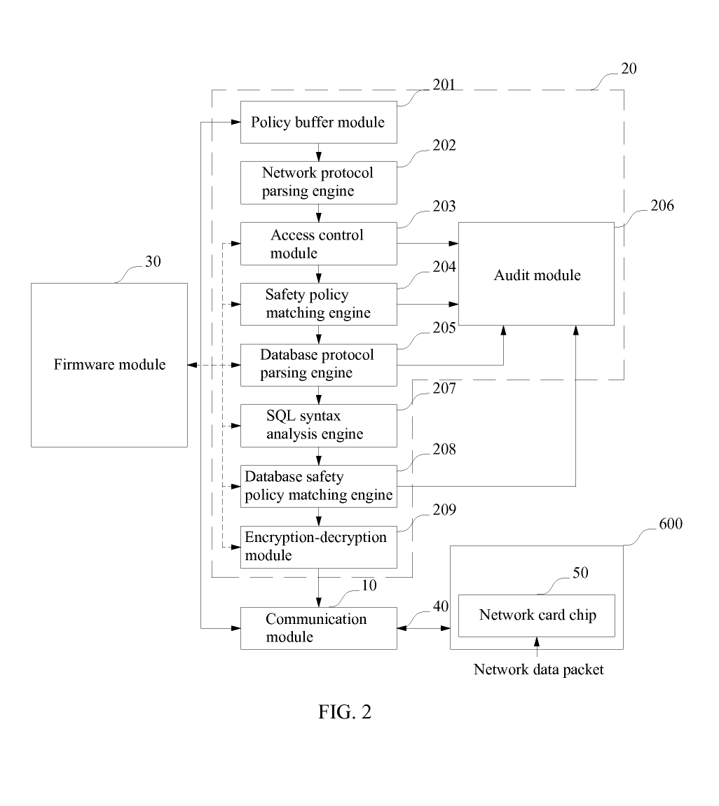

As shown in FIG. 1 and FIG. 2, the embodiments of the present invention provide a safety device 500, comprising:

a communication module 10, used to be butted with an external communication interface 40 provided by a server 600 and realize information interaction with the server 600 through the interface;

a firmware module 30, used to be pre-configured with at least one safety control policy; and

a processing module 20, used to perform at least one of the safety control policies so as to realize the information safety protection of the server 600 in real time when the server 600 detects the safety device 500.

It is not difficult for those skilled in the art to realize the communication module 10, the firmware module 30 and the processing module 20 industrially with reference to the spirit of the present invention and the prior art. Specifically, the firmware module 30 is pre-configured with at least one safety control policy. The processing module 20 performs at least one of the safety control policies in real time so as to realize the information safety protection of the server 600 when the server 600 detects that the safety device 500 is connected thereon.

The safety protection includes but is not limited to: database granule encryption and decryption, transparent encryption and decryption, ciphertext index and ciphertext retrieval, database firewall, database access event sourcing, operating system access control, operating system kernel hardening, unstructured data encryption and decryption, structured data encryption and decryption, server management information, working state server control, network firewall and access control. The safety policies include but are not limited to: application safety policy, data safety policy, operating system safety policy, database safety policy (for example, encryption and decryption policy of database data, encryption and decryption policy of database structure), network safety policy, access control policy and safety audit policy and the like. In practical application, the user may increase, delete and modify the safety control policies.

Besides, the safety device 500 may further provide an expansion interface so as to realize function expansion, for example, providing flexible expansions for such safety products and technologies as dependable computing, VPN, anti-virus, fingerprint identification, PKI authentication, encryption, application protection and safety audit and the like.

In the embodiment, the safety device 500 is in communication connection with the external communication interface 40 of the server 600 in a pluggable manner. Specifically, the safety device 500 is a pluggable device, wherein a communication module 10 simultaneously serving as a plugging terminal is butted with the external communication interface 40 used for plugging the safety device 500 provided by the server 600. More specifically, when the safety device 500 is a pluggable device, the pluggable device is a card or a mobile medium.

In another embodiment, the safety device 500 is integrated on a motherboard of the server 600, and is in communication connection with the external communication interface 40 of the server 600.

Preferably, when a network card chip 50 acquires a network data packet, the communication module 10 is used to acquire the network data packet from the network card chip 50, wherein the network card chip 50 may be deployed above the server 600. Referring to FIG. 2, the processing module 20 comprises:

a network protocol parsing engine 202, used to carry out network protocol parsing on the network data packet; for example, the network protocol is such a protocol as a TCP (Transmission Control Protocol, transmission control protocol) and the like;

an access control module 203, used to analyze whether current user access is safe or not according to a network protocol parsing result and at least one safety control policy acquired from the safety device 500; if the current user access is safe, then allow the network data packet to pass; otherwise, block the network data packet and notify an audit module 206 to audit; and

the audit module 206, used to audit the network data packet.

Preferably, the processing module 20 further comprises:

a policy buffer module 201, used to save the safety control policy updated by a user and update the updated safety control policy to the firmware module 30 when the user accesses the server 600.

Preferably, the processing module 20 further comprises:

a safety policy matching engine 204, used to detect the network data packet which is allowed to pass according to at least one safety control policy acquired from the safety device 500, so as to judge whether the network data packet is allowed to pass; if yes, then allow the network data packet to pass; otherwise, block the network data packet and notify the audit module 206 to audit;

a database protocol parsing engine 205, used to parse the network data packet which is allowed to pass according to various database protocol characters;

an SQL syntax analysis engine 207, used to analyze SQL statements parsed by the database protocol parsing engine 205 according to at least one safety control policy acquired from the safety device 500, so as to judge whether the access to the database is legal;

a database safety policy matching engine 208, used to detect the network data packet which is allowed to pass according to at least one safety control policy acquired from the safety device 500, so as to judge whether the network data packet is allowed to pass; if yes, then allow the network data packet to pass; otherwise, block the network data packet and notify the audit module 206 to audit; and

an encryption-decryption module 209, used to encrypt and decrypt the network data packet which is allowed to pass according to at least one safety control policy acquired from the safety device 500.

In a specific embodiment:

the encryption-decryption module comprises structured data encryption and decryption and unstructured data encryption and decryption. The structured data encryption and decryption aims at performing encryption and decryption on structured data; unstructured data encryption and decryption aims at performing encryption and decryption on unstructured data (for example: file, image, video and the like).

The access control module comprises hardening of an operating system: an operating system inner core hardening technology ensures the safety of the bottom layer of the entire information safety system through protecting the inner core layer of the operating system at the bottom information safety operating system, wherein the core of the technology is to restructure a permission access model of the operating system in the core layer of the operating system to realize real mandatory access control.

The network protocol parsing engine comprises a network firewall: used for deeply and clearly see through users, applications and contents in network flow and provide effective network layer-application layer integrated safety protection for the users.

The access control module: performing control on database access and network access.

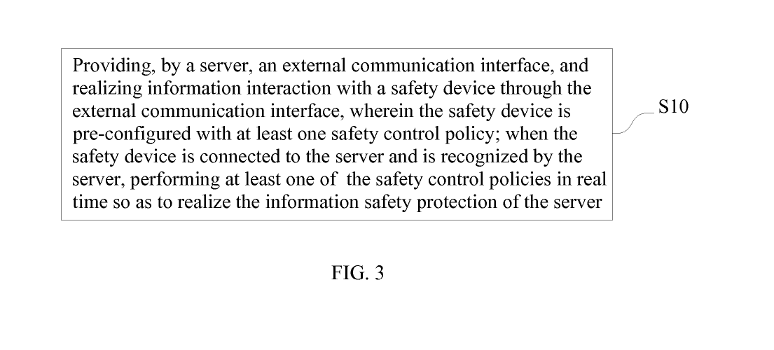

The specific working steps of the safety device 500 are described in details hereinafter with reference to FIG. 3 and taking the pluggable safety device 500 for example, wherein the following steps are comprised.

Step S00: A user installs a safety device 500 onto a server 600 requiring protection.

Step S01: When the user accesses the server 600, a policy buffer module 201 saves the settings of the user, wherein these settings include the safety control policy of the server 600 initiatively inputted by the user.

Step S02: The user accesses the server 600.

Step S03: The safety device 500 acquires a network data packet through a network card chip 50 of the server 600.

Step S04: A network protocol parsing engine 202 parses the network data packet according to various protocol characteristics.

Step S05: An access control module 203 analyzes whether the network data packet corresponds with access safety according to a network protocol parsing result and a safety control policy obtained from the safety device 500 or directly acquired from a policy buffer module 201; if the network data packet corresponds with access safety, then allows the network data packet to pass; otherwise, blocks and audits the network data packet.

Step S06: A safety policy matching engine 204 performs safety policy matching on the network data packet allowed to pass by the access control module 203 according to the safety control policy obtained from the safety device 500 or directly acquired from the policy buffer module 201 so as to check whether the network data packet is allowed to pass; if yes, allows the network data packet to pass; otherwise, blocks and audits the network data packet; if not, blocks and audits the network data packet.

Step S07: A database protocol parsing engine 205 parses the network data packet according to various database protocol characteristics.

Step S08: A database safety policy matching engine 208 performs safety policy matching on the network data packet allowed to pass by the safety policy matching engine 204 according to the safety control policy obtained from the safety device 500 or directly acquired from the policy buffer module 201 so as to check whether the network data packet is allowed to pass; if yes, allows the network data packet to pass; otherwise, blocks and audits the network data packet; if not, blocks and audits the network data packet.

Step S09: An encryption-decryption module 209 judges whether to encrypt and decrypt the data included in the network data packet according to the safety control policy obtained from the safety device 500 or directly acquired from the policy buffer module 201; if yes, encrypts and decrypts the data included in the network data packet allowed to pass.

Continuously referring to FIG. 2, the embodiments of the present invention further provides a server 600, which is connected with a safety device 500, wherein the safety device 500 comprises:

a communication module 10, used to be butted with an external communication interface 40 provided by the server 600 and realize information interaction with the server 600 through the interface;

a firmware module 30, used to be pre-configured with at least one safety control policy; and

a processing module 20, used to perform at least one of the safety control policies so as to realize the information safety protection of the server 600 in real time when the server 600 detects the safety device 500 is connected thereon.

In specific implementation, the server 600 itself peels off various safety control software that realizes the safety protection, for example, network firewall software and the like. When specific protection is required to perform on the corresponding server 600, a specific user holding the jurisdiction of the corresponding safety device 500 only needs to plug the safety device 500 onto the server 600, or the corresponding user operates the server 600 integrated with the safety device 500, thus being capable of realizing the safety protection of the server 600.

Preferably, the safety device 500 may be a card or a mobile medium such as a USB flash disk and the like, which is in communication connection with the external communication interface 40 of the server 600 in a pluggable manner; or

the safety device 500 is integrated on a motherboard of the server 600, and is in communication connection with the external communication interface 40 of the server 600.

Similarly, when the network card chip 50 of the server 600 acquires a network data packet, the communication module 10 of the safety device 500 is used to acquire the network data packet from the network card chip 50, wherein the processing module 20 comprises:

a network protocol parsing engine 202, used to carry out network protocol parsing on the network data packet; for example, the network protocol is such a protocol as a TCP (Transmission Control Protocol, transmission control protocol) and the like.

an access control module 203, used to analyze whether current user access is safe or not according to a network protocol parsing result and at least one safety control policy acquired from the safety device 500; if the current user access is safe, then allow the network data packet to pass; otherwise, block the network data packet and notify an audit module 206 to audit; and

the audit module 206, used to audit the network data packet.

Preferably, the processing module 20 further comprises:

a policy buffer module 201, used to save the safety control policy updated by a user and update the updated safety control policy to the firmware module 30 when the user accesses the server 600.

Preferably, the processing module 20 further comprises:

a safety policy matching engine 204, used to detect the network data packet which is allowed to pass according to at least one safety control policy acquired from the safety device 500, so as to judge whether the network data packet is allowed to pass; if yes, then allow the network data packet to pass; otherwise, block the network data packet and notify the audit module 206 to audit;

a database protocol parsing engine 205, used to parse the network data packet which is allowed to pass according to various database protocol characters;

an SQL syntax analysis engine 207, used to analyze SQL statements parsed by the database protocol parsing engine 205 according to at least one safety control policy acquired from the safety device 500, so as to judge whether the access to the database is legal;

a database safety policy matching engine 208, used to detect the network data packet which is allowed to pass according to at least one safety control policy acquired from the safety device 500, so as to judge whether the network data packet is allowed to pass; if yes, then allow the network data packet to pass; otherwise, block the network data packet and notify the audit module 206 to audit;

an encryption-decryption module 209, used to encrypt and decrypt the network data packet which is allowed to pass according to at least one safety control policy acquired from the safety device 500.

As shown in FIG. 3 and referring to FIG. 2, the embodiments of the present invention further provide a server 600 information safety realizing method, which comprises the steps as follows.

S10: Providing, by a server 600, an external communication interface 40, and realizing information interaction with a safety device 600 through the external communication interface 40, wherein the safety device 500 is pre-configured with at least one safety control policy; when the safety device 500 is connected to the server 600 and is recognized by the server, performing at least one of the safety control policies in real time so as to realize the information safety protection of the server 600.

In the embodiment, the safety device 500 is in communication connection with the external communication interface 40 of the server 600 in a pluggable manner. In the embodiment, when realizing the specific application of the server 600, the safety device 500 integrating the safety function and the network card function is adopted. The safety protection of the server 600 can be realized by as long as plugging the safety device 500 into the corresponding interface, so that the server 600 when performing an actual business, selects at least one safety control policy to perform safety control processing through performing information interaction with the safety device 500.

Or, in another embodiment, the safety device 500 is integrated on a motherboard of the server 600, and is in communication connection with the external communication interface 40 of the server 600. In the embodiment, when realizing the specific application of the server 600, the safety device 500 integrating the safety function and the network card function is adopted, and the safety device 500 is integrated onto the motherboard of the server 600. The safety protection of the server 600 can be realized by as long as plugging the safety device 500 into the corresponding interface, so that the server 600 when performing an actual business, selects at least one safety control policy to perform safety control processing through performing information interaction with the safety device 500.

According to the spirit of the present invention, those skilled in the art should know that: the safety control policies written in the safety device 500 include, but are not limited to application safety policy, data safety policy, operating system safety policy, database safety policy (for example, encryption and decryption policies of database data, encryption and decryption policies of database structures), network safety policy and safety audit policy and the like. In practical application, the user may increase, delete and modify the safety control policies.

Preferably, the step of performing at least one of the safety control policies in real time so as to realize the information safety protection of the server 600 when the safety device 500 is connected to the server 600 and recognized by the server, comprises:

Step S100: Acquiring a network data packet when the user accesses the server 600.

Step S100: Carrying out network protocol parsing on the network data packet.

Step 110: Analyzing whether current user access is safe according to a network protocol parsing result and at least one safety control policy acquired from the safety device 500; if the current user access is safe, then allowing the network data packet to pass; otherwise, blocking and auditing the network data packet.

Step S100: Detecting the network data packet which is allowed to pass according to at least one safety control policy acquired from the safety device 500, so as to judge whether the network data packet is allowed to pass; if yes, then allowing the network data packet to pass; otherwise, blocking and auditing the network data packet.

Step S100: Parsing the network data packet which is allowed to pass according to various database protocol characters.

Step S100: Performing safety policy matching on the network data packet which is allowed to pass according to at least one safety control policy acquired from the safety device 500, so as to judge whether the network data packet is allowed to pass; if yes, then allowing the network data packet to pass; otherwise, blocking and auditing the network data packet.

Step S100: Encrypting and decrypting the network data packet which is allowed to pass according to at least one safety control policy acquired from the safety device 500.

The foregoing descriptions are merely preferred embodiments of the present invention, but do not thus limit the protection scope of the present invention. Any equivalence structure or equivalence flow transformation figured out by utilizing the specification and the accompanying drawings of the present invention or directly or indirectly applied to other related technical fields shall all similarly fall within the protection scope of the present invention.

What is claimed is:

1. A safety device, comprising:
a communication module, used to be butted with an external communication interface provided by a server and realize information interaction with the server through the interface;
a firmware module, used to be pre-configured with at least one safety control policy; and
a processing module, used to perform at least one of the safety control policies so as to realize the information safety protection of the server in real time when the server detects the safety device.

2. The safety device according to claim 1, wherein the safety device is in communication connection with the external communication interface of the server in a pluggable manner; or
the safety device is integrated on a motherboard of the server, and is in communication connection with the external communication interface of the server.

3. The safety device according to claim 1, wherein when a network card chip acquires a network data packet, the communication module is used to acquire the network data packet from the network card chip; and the processing module comprises:
a network protocol parsing engine, used to carry out network protocol parsing on the network data packet;
an access control module, used to analyze whether current user access is safe according to a network protocol parsing result and at least one safety control policy acquired from the safety device; if the current user access is safe, then allow the network data packet to pass; otherwise, block the network data packet and notify an audit module to audit; and
the audit module, used to audit the network data packet.

4. The safety device according to claim 3, wherein the processing module further comprises:
a policy buffer module, used to save the safety control policy updated by a user and update the updated safety control policy to the firmware module when the user accesses the server.

5. The safety device according to claim 3, wherein the processing module further comprises:
a safety policy matching engine, used to detect the network data packet which is allowed to pass according to at least one safety control policy acquired from the safety device, so as to judge whether the network data packet is allowed to pass; if yes, then allow the network data packet to pass; otherwise, block the network data packet and notify the audit module to audit;
a database protocol parsing engine, used to parse the network data packet which is allowed to pass according to various database protocol characters;
an SQL syntax analysis engine, used to analyze SQL statements parsed by the database protocol parsing engine according to at least one safety control policy acquired from the safety device, so as to judge whether the access to the database is legal;
a database safety policy matching engine, used to perform safety policy matching on the network data packet which is allowed to pass according to at least one safety control policy acquired from the safety device, so as to judge whether the network data packet is allowed to pass; if yes, then allow the network data packet to pass; otherwise, block the network data packet and notify the audit module to audit; and
an encryption-decryption module, used to encrypt and decrypt the network data packet which is allowed to pass according to at least one safety control policy acquired from the safety device.

6. The safety device according to claim 2, wherein the safety device connected with the server in a pluggable manner is a card or a mobile medium.

7. The safety device according to claim 5, wherein the encryption module comprises to encrypt and decrypt structured data and encrypt and decrypt unstructured data including file, image, video and the like.

8. The safety device according to claim 3, wherein the access control module comprises hardening of an operating system, which focuses on restructuring a permission access model of the operating system in a core layer of the operating system to realize real mandatory access.

9. The safety device according to claim 3, wherein the network protocol parsing engine comprises a network firewall which is used to deeply and clearly see through users, applications and contents in network flow and provide effective network layer-application layer integrated safety protection for the users.

10. The safety device according to claim 3, wherein the access control module performs control on database access and network access.

11. A server, wherein the server is connected with a safety device, and the safety device comprises:
a communication module, used to be butted with an external communication interface provided by a server and realize information interaction with the server through the interface;
a firmware module, used to be pre-configured with at least one safety control policy; and
a processing module, used to perform at least one of the safety control policies so as to realize the information safety protection of the server in real time when the server detects the safety device is connected thereon.

12. The server according to claim 7, wherein the safety device is in communication connection with an external communication interface of the server in a pluggable manner, or
the safety device is integrated on a motherboard of the server, and is in communication connection with the external communication interface of the server.

13. A server information safety realizing method, comprising the steps of:
providing, by a server, an external communication interface, and realizing information interaction with a safety device through the external communication interface, wherein the safety device is pre-configured with at least one safety control policy; when the safety device is connected to the server and is recognized by the server, performing at least one of the safety control policies in real time so as to realize the information safety protection of the server.

14. The server information safety realizing method according to claim 9, wherein the safety device is in communication connection with the external communication interface of the server in a pluggable manner, or
the safety device is integrated on a motherboard of the server, and is in communication connection with the external communication interface of the server.

15. The server information safety realizing method according to claim 9, wherein the step of performing at least one of the safety control policies in real time so as to realize the information safety protection of the server when the safety device is connected to the server and is recognized by the server, comprises:
acquiring a network data packet when a user accesses the server;
performing network protocol parsing on the network data packet;
analyzing whether current user access is safe according to a network protocol parsing result and at least one safety control policy acquired from the safety device; if yes, then allowing the network data packet to pass; otherwise, blocking and auditing the network data packet; and
detecting the network data packet which is allowed to pass according to at least one safety control policy acquired from the safety device, so as to judge whether the network data packet is allowed to pass; if yes, then allowing the network data packet to pass; otherwise, blocking the network data packet and notifying the audit module to audit;
parsing the network data packet which is allowed to pass according to the characters of various database protocols;
performing safety policy matching on the network data packet which is allowed to pass according to at least one safety control policy acquired from the safety device, so as to judge whether the network data packet is allowed to pass; if yes, then allow the network data packet to pass; otherwise, block the network data packet and notify the audit module to audit; and
encrypting and to decrypting the network data packet which is allowed to pass according to at least one safety control policy acquired from the safety device.
